(19) United States
(12) Patent Application Publication
(10) Pub. No.: US 2025/0370434 A1
(43) Pub. Date: Dec. 4, 2025

(54) MILKING PLANT SYSTEM, COMPUTER-IMPLEMENTED METHOD, COMPUTER PROGRAM AND NON-VOLATILE DATA CARRIER

(71) Applicant: DELAVAL HOLDING AB, Tumba (SE)

(72) Inventor: Marcin BAK, Tumba (SE)

(21) Appl. No.: 18/867,387

(22) PCT Filed: May 16, 2023
(86) PCT No.: PCT/SE2023/050479

§ 371 Date: Nov. 19, 2024

(30) Foreign Application Priority Data
May 20, 2022 (SE) 2250606-7

(51) Int. Cl. G05B 19/418

(52) U.S. Cl. CPC G05B 19/41835; G05B 2219/31101

(57) ABSTRACT

Via at least one network, a remote server sends configuration data to a local server at a farm having a milking plant system with a set of farm components. Each of the farm components is operatively connected to a respective controller that is configurable by a set of configuration parameters included in the configuration data. In response to receiving the configuration data, the local server transmits a respective set of configuration parameters to each of the respective controllers. In response to receiving the set of configuration parameters each of the respective controllers sets a configuration of the controller in accordance with the respective set of configuration parameters for that controller. Thus, the farm components of the milking plant system can be configured and upgraded in a convenient and efficient manner.

### TECHNICAL FIELD

The present invention relates generally to milking installations that include software-controlled farm components. Especially, the invention relates to a milking plant system according to the preamble of claim 1 and a corresponding computer-implemented method. The invention also relates to a computer program and a non-volatile data carrier storing such a computer program.

### BACKGROUND

Today's milking systems are highly complex installations in which a multitude of components and pieces of equipment interact in various ways. It is therefore no trivial task to set up and organize a milking system in a functionally optimal manner. So far, one solution is known for automatically configuring a single unit in the form milk analysis apparatus.

WO 2020/251456 describes a solution, wherein a milk analysis apparatus contains a first wireless communication device for communicating with a memory device of a configuration tag. The con-figuration tag is applicable to the milk analysis apparatus and contains a reference sign of a milk extracting arrangement to which the milk analysis apparatus is intended to work in conjunction with. The communication is made via a second wireless communication device included in the configuration tag. The control unit is configured to retrieve configuration data, e.g. a network location reference such as an IP address, of the milk extracting arrangement that the milk analysis apparatus is intended to operate in conjunction with, from the memory device of the configuration tag via the first wireless communication device; and to configure the control unit based on the retrieved configuration data of the milk extracting arrangement.

Although the above solution may provide efficient configuration of a milk analysis apparatus, the problem of configuring an entire milking plant remains to be solved.

### SUMMARY

The object of the present invention is therefore to offer a solution that enables straightforward and reliable configuration of an entire milking plant system.

According to one aspect of the invention, the object is achieved by a milking plant system including a local server and a set of farm components. The local server is arranged at a farm, and the local server is configured to obtain configuration data from a remote server over at least one network, e.g. the Internet. Each component in the set of farm components is operatively connected to a respective controller, which, in turn, is configurable by a set of configuration parameters in the configuration data obtained in the local server. Further, each of the controllers is communicatively connected to the local server. The local server is configured to receive a configuration file from the remote server, which configuration file contains a respective set of configuration parameters for each of the respective controllers. The configuration file, in turn, has been generated based on a defining message identifying the components in the set of farm components. In response to the configuration file, the local server is configured to transmit the respective set of configuration parameters to each of the respective controllers. Each of the respective controllers is configured to: receive the respective set of configuration parameters, and in response thereto set a configuration of the controller in accordance with the respective set of configuration parameters for that controller.

This milking plant system is advantageous because it enables convenient and efficient remote configuration of all the farm components included in the milking plant system.

According to one embodiment of this aspect of the invention, each component in the set of farm components has a respective machine-readable label denoting a respective identity of the component. The machine-readable label is configured to be read by a machine reader in the form of an optical reader, a radio-frequency-identification reader and/or a near-field-communication reader. The defining message is based on the machine-readable labels.

For example, the above-, mentioned at least one reader may be included in a mobile terminal, such as a smartphone or tablet computer, which at least one reader is configured to read each of the machine-readable labels. Based thereon, the mobile terminal is further configured to produce the defining message, and transmit the defining message to the remote server, e.g. over a wireless network. This is a very user-friendly means of providing the remote server with the defining messages.

According to another embodiment of this aspect of the invention, the mobile terminal is configured to receive user-input data specifying how each component in the set of farm components is arranged in relation to at least one other component of the milking plant system at the farm. The mobile terminal is also configured to produce the defining message on the further basis of the user-input data. This is beneficial because configuring the components of a milking plant typically requires appropriate interrelation information in addition to information identifying the components as such.

According to yet another embodiment of this aspect of the invention, a mobile terminal is included in the milking plant system, which mobile terminal is configured to receive positioning signals from a positioning system, e.g. a so-called GNSS (global navigation satellite system) like the GPS (global positioning system). Based on the received positioning signals, the mobile terminal is configured to determine a position for the mobile terminal. Moreover, based on the position for the mobile terminal, the mobile terminal is configured to produce the defining message, and subsequently, transmit the defining message to the remote server. Assuming that (a) the mobile terminal is positioned at the farm where the milking plant to be configured is located, and (b) the mobile terminal contains, or has access to information about which components are included in this milking plant, the configuration thereof can be effected in a highly efficient manner.

According to still another embodiment of this aspect of the invention, an auxiliary server disposes of a second database containing farm installation data describing the configuration of each component in the set of farm components. The configuration is presumed to be linked to a respective identity of each component in the set of farm components. Further, the auxiliary server is configured to produce the defining message based on the respective identity of each component in the set of farm components, and transmit the defining message to the remote server. Thus, the milking plant system can be configured exclusively based on advance knowledge about the components included in the milking plant system.

According to another embodiment of this aspect of the invention, one of the respective controllers is specifically a milking controller operatively connected to a milking parlor, another one is a cleaning controller operatively connected to a cleaning arrangement configured to perform a clean-in-place procedure in respect of at least a part of a milking parlor and/or yet another one is a cooling controller operatively connected to cooling tank configured to hold extracted milk. Namely, these constitute the key parts of a typical milking plant system

According to a further embodiment of this aspect of the invention, the milking parlor, in turn, contains at least one milking point that is connected to a vacuum source, at least one pulsator and at least one milk meter, and the milking controller is configured to monitor the at least one milking point, the vacuum source, the at least one pulsator and at the least one milk meter. In this embodiment, the cooling tank contains at least one agitating member, an evaporator and a compressor; and the cooling controller is configured to monitor the at least one agitating member, the evaporator as well as the compressor. This type of multi-component control is beneficial from an efficiency point-of-view.

According to another aspect of the invention, the object is achieved by a computer-implemented method, which is performed in at least one processor in a local server of a milking plant system at a farm and in each of a respective controller being operatively connected to a farm component in a set of farm components included in the milking plant system. Each of the controllers is configurable by a set of configuration parameters in the configuration data obtained from a remote server over at least one network, e.g. the Internet. Further, each of the controllers is communicatively connected to the local server. The method involves receiving a configuration file from the remote server in the local server. The configuration file contains a respective set of configuration parameters for each of the controllers, and the configuration file has been generated based on a defining message identifying the components in the set of farm components. In response to the configuration file, the method further involves transmitting the respective set of configuration parameters from the local server to each of the respective controllers. In each of the respective controllers, the method involves receiving the respective set of configuration parameter, and in response thereto setting a configuration of the controller in accordance with the respective set of configuration parameters for that controller.

The advantages of this method, as well as the preferred embodiments thereof, are apparent from the discussion above with reference to the proposed milking plane system.

According to a further aspect of the invention, the object is achieved by a computer program loadable into a non-volatile data carrier communicatively connected to a processing unit. The computer program includes software for executing the above method when the program is run on the processing unit.

According to another aspect of the invention, the object is achieved by a non-volatile data carrier containing the above computer program.

Further advantages, beneficial features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIG. 1 shows an example of a milking plant system according to a first embodiment of the invention;

FIG. 2 shows an example of a milking plant system according to a second embodiment of the invention;

FIG. 3 shows an example of a milking plant system according to a third embodiment of the invention;

FIG. 4 shows a block diagram of a local server according to one embodiment of the invention; and

FIG. 5 illustrates, by means of a flow diagram, the general method according to the invention.

### DETAILED DESCRIPTION

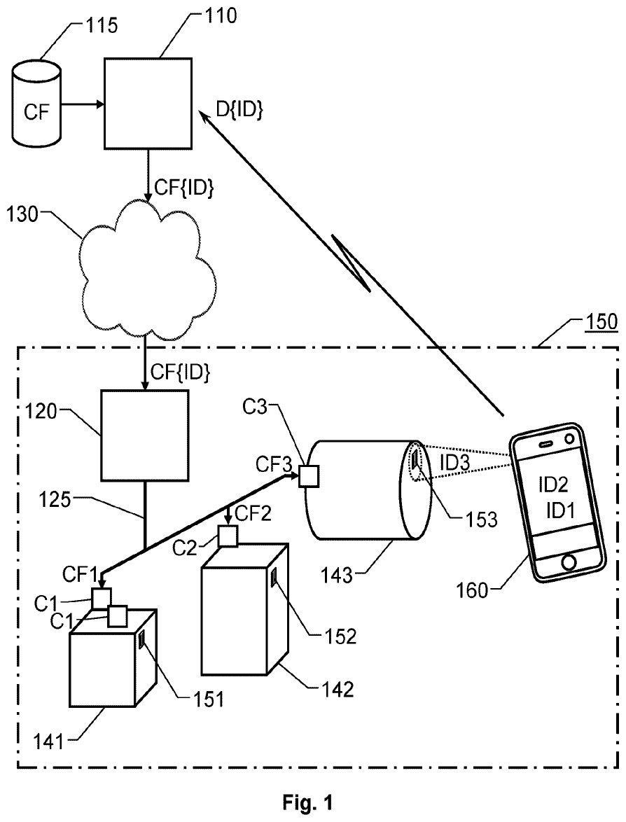

FIG. 1 shows example of a milking plant system according to a first embodiment of the invention. The milking plant system contains a local server 120 and a set of farm components, here generally symbolized by 141, 142 and 143 respectively.

The local server 120 is arranged at a farm 150 where a milking plant system to be configured is located. The local server 120 is configured to obtain configuration data CF from a remote server 110 over at least one network 130, e.g. represented by the Internet.

Each farm component in the set of farm components 141, 142 and 143 is operatively connected to a respective controller C1, C2 and C3, which, in turn, is configurable by a set of configuration parameters comprised in the configuration data CF. Each of the controllers C1, C2 and C3 is further communicatively connected to the local server 120, e.g. wirelessly.

The local server 120 is configured to receive a configuration file CF{ID} from the remote server 110. The configuration file CF{ID} contains a respective set of configuration parameters CF1, CF2 and CF3 for each of the respective controllers C1, C2 and C3.

The configuration file CF{ID} has been generated based on a defining message D{ID} identifying the components in the set of farm components 141, 142 and 143. In response to the configuration file CF{ID}, the local server 120 is configured to transmit the respective set of configuration parameters CF1, CF2 and CF3 to each of said respective controllers C1, C2 and C3 for example via a network 125, which may be wired (e.g. of Ethernet type) and/or wireless (e.g. of Wi-Fi or Bluetooth type).

Each of the controllers C1, C2 and C3 is configured to receive the respective set of configuration parameters CF1, CF2 and CF3 respectively. In response thereto, each of the controllers C1, C2 and C3 is configured to set a configuration of the controller in question C1, C2 and C3 in accordance with the respective set of configuration parameters CF1, CF2 and CF3 for that controller C1, C2 and C3 respectively. Consequently, all the controllers C1, C2 and C3 are configured in agreement with the configuration file CF{ID}.

According to one embodiment of the invention, a first controller C1 is a milking controller operatively connected to a milking parlor. The milking parlor may contain at least one milking point that is connected to a vacuum source. The milking parlor may further contain at least one pulsator and at least one milk meter. In such a case, the milking controller C1 is configured to monitor the at least one milking point, the vacuum source, the at least one pulsator and at the least one milk meter.

A second controller C2 may be a cleaning controller operatively connected to a cleaning arrangement configured to perform a clean-in-place procedure in respect of at least a part of a milking parlor; and a third controller C3 is a cooling controller operatively connected to cooling tank configured to hold extracted milk. The cooling tank, in turn, may contain at least one agitating member, an evaporator and a compressor. Here, the cooling controller C3 is configured to monitor the at least one agitating member, the evaporator and the compressor. Thereby, an entire milking plant system can be configured via the configuration file CF{ID}. As will be described below, according to embodiments of the invention, the configuration file CF{ID} may be transmitted to the local server 120 based on different prompters.

In the example shown in FIG. 1, each component in the set of farm components 141, 142 and 143 is provided with a respective machine-readable label 151, 152 and 153 respectively. Each machine-readable label 151, 152 and 153 denotes a respective identity ID1, ID2 and ID3 of the component on which the machinereadable label 151, 152 and 153 is provided. The machine-readable labels 151, 152 and 153 are configured to be read by a machine reader, such as an optical reader, a radio-frequency-identification reader and/or a near-field-communication reader. Here, the defining message D{ID} is based on the machine-readable labels 151, 152 and 153.

For example, a mobile terminal 160 may be included in the milking plant system, which mobile terminal 160 contains at least one reader configured to read each of the machine-readable labels 151, 152 and 153 respectively. The mobile terminal 160 can be represented by a smartphone, a tablet computer, a laptop, or similar portable device. The mobile terminal 160 is configured to produce the defining message D{ID} based on the identities ID1, ID2 and ID3 of the controllers C1, C2 and C3 read from the machinereadable label 151, 152 and 153 thereon. Moreover, the mobile terminal 160 is configured to transmit the defining message D{ID} to the remote server 110, for example via a wireless access network.

Typically, in order to configure a controller of a milking plant system in addition to information about the type of component controlled by the controller and the features/capabilities of this component, details are needed concerning how the component is related to other components in the milking plant system. Therefore, according to one embodiment of the invention, the mobile terminal 160 is further configured to receive user-input data specifying how each component in the set of farm components, e.g. 141, 142 and 143 is arranged in relation to at least one other component of the milking plant system at the farm 150. The userinput data in question may thus describe how different pressure sensors monitored by the controllers are arranged along a milk line. Alternatively, or additionally, the user-input data in question may reflect a layout of the farm 150. The mobile terminal 160 is here configured to produce the defining message D{ID} on the further basis of the user-input data.

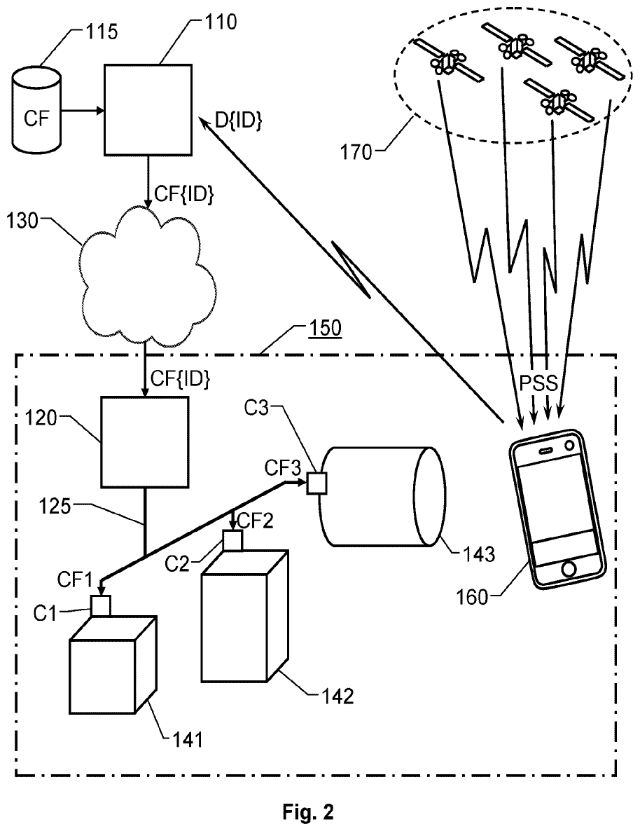

FIG. 2 shows an example of a milking plant system according to a second embodiment of the invention. In FIG. 2, all reference numerals that also occur in FIG. 1 designate the same components/devices as described above with reference to FIG. 1.

Here, a mobile terminal 160 of the system is configured to receive positioning signals PSS from a positioning system 170, e.g. a mobile telephone system or a GNSS, such as the GPS, Galileo, Glonass (Globalnaya Navigatsionnaya Sputnikovaya Sistema), BeiDou-2, QZSS (Quasi-Zenith Satellite System), IRNSS (Indian Regional Navigation Satellite System) or NavIC. Based on the received positioning signals PSS, the mobile terminal 160 is configured to determine a position for the mobile terminal 160. The mobile terminal 160 contains, or has access to information that links each farm 150 in a set of farms to respective position data for that farm 150. Thus, based on the position data, the mobile terminal 160 may identify a particular farm, and based on the position for the mobile terminal 160, the mobile terminal 160 is configured to produce the defining message D{ID}. Additionally, the mobile terminal 160 is configured to transmit the defining message D{ID} to the remote server 110, for example via a wireless access network. In response to the defining message D{ID}, the remote and local servers 110 and 120 respectively are configured to operate as described above with reference to FIG. 1.

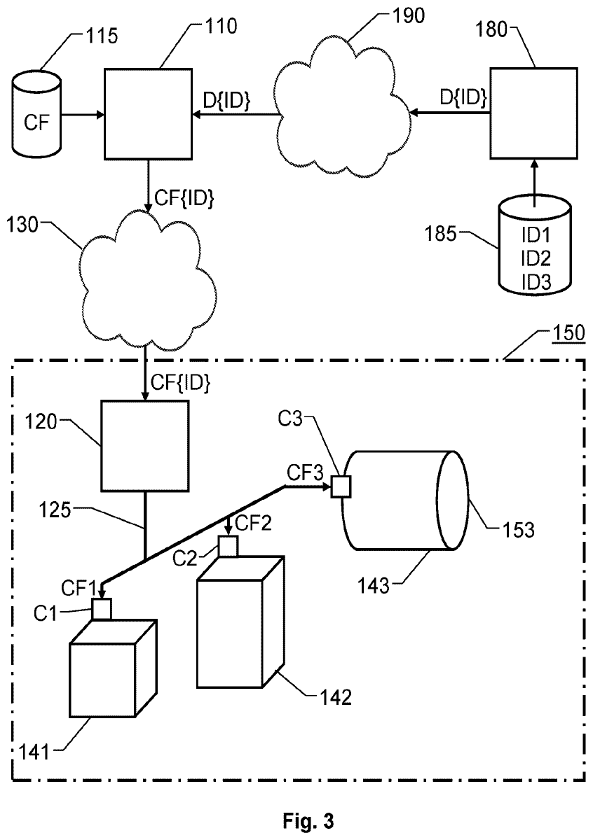

FIG. 3 shows an example of a milking plant system according to a third embodiment of the invention. In FIG. 3, all reference numerals that also occur in FIGS. 1 and/or 2 designate the same components/devices as described above with reference to FIGS. 1 and/or 2. In the example shown in FIG. 3, the milking plant system contains an auxiliary server 180 that disposes of a second database 185. The second database 185 contains farm installation data describing the configuration of each component in the set of farm components 141, 142 and 143. Analogous to the above, configuration is linked to a respective identity ID1, ID2 and ID3 of each component in the set of farm components 141, 142 and 143. The auxiliary server 180 is configured to produce the defining message D{ID} based on the respective identity ID1, ID2 and ID3 of each component in the set of farm components 141, 142 and 143 respectively; and transmit the defining message D{ID} to the remote server 110, for example via at least one network, such as the Internet. In response to the defining message D{ID}, the remote and local servers 110 and 120 respectively are configured to operate as described above with reference to FIG. 1. Hence, the farm components 141, 142 and 143 may be configured in an entirely automatic manner from a remote location, for instance the remote server 110.

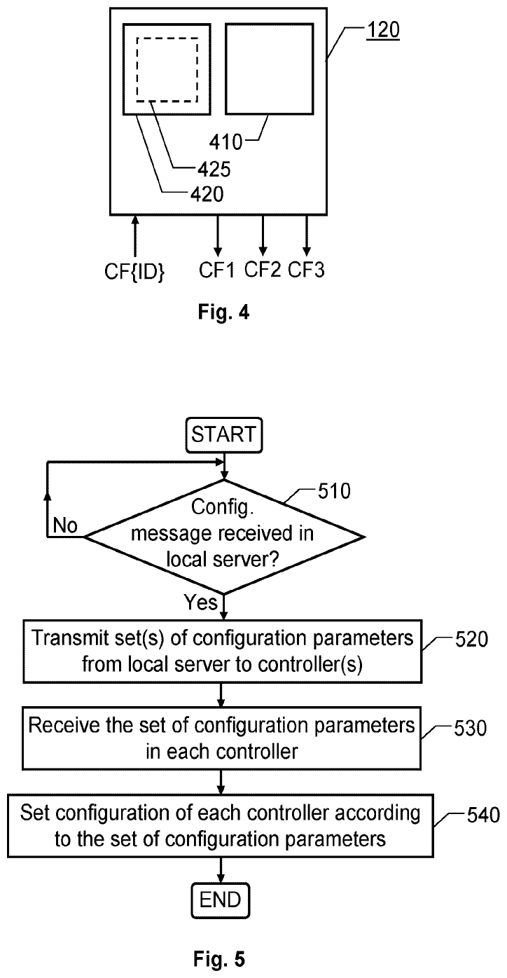

FIG. 4 shows a block diagram of a local server 120 according to one embodiment of the invention. It is generally advantageous if the local server 120 is configured to effect the above-described procedure in conjunction with the remote server 110 in an automatic manner by executing a computer program 425. Therefore, the local server 120 may include a memory unit 420, i.e. nonvolatile data carrier, storing the computer program 425, which, in turn, contains software for making processing circuitry in the form of at least one processor 410 in the local server 120 execute the actions mentioned in this disclosure when the computer program 425 is run on the at least one processor 410.

In order to sum up, and with reference to the flow diagram in Figure 5, we will now describe the computer-implemented method according to the invention which is performed in the local server 120 and a set of controllers C1, C2 and C3 communicatively connected thereto.

A first step 510 checks if a configuration file CF{ID} from the remote server 110 has been received in the local server 120. If so, a step 520 follows; and otherwise, the procedure loops back and stays in step 510. The configuration file CF{ID} contains a respective set of configuration parameters CF1, CF2 and CF3 for each of the controllers C1, C2 and C3 respectively. The configuration file CF{ID} has been generated based on a defining message D{ID} identifying the components in the set of farm components 141, 142 and 143.

In step 520, the respective set of configuration parameters CF1, CF2 and CF3 are transmitted from the local server 120 to each of said respective controllers C1, C2 and C3, for example via a wired or wireless network.

Subsequently, in a step 530, the respective set of configuration parameters CF1, CF2 and CF3 are received in each of the respective controllers C1, C2 and C3. Then, in response thereto, in a step 540, a configuration of in each the controllers C1, C2 and C3 is set in accordance with the respective set of configuration parameters CF1, CF2 and CF3 for that controller C1, C2 and C3. Thereafter, the procedure ends.

The process steps described with reference to FIG. 5 may be controlled by means of a programmed processor. Moreover, although the embodiments of the invention described above with reference to the drawings comprise processor and processes performed in at least one processor, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The program may either be a part of an operating system, or be a separate application.

The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal, which may be conveyed, directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

Variations to the disclosed embodiments can be understood and effected by those skilled in the art in practicing the claimed invention, from a study of the drawings, the disclosure, and the appended claims.

The term “comprises/comprising” when used in this specification is taken to specify the presence of stated features, integers, steps or components. The term does not preclude the presence or addition of one or more additional elements, features, integers, steps or components or groups thereof. The indefinite article “a” or “an” does not exclude a plurality. In the claims, the word “or” is not to be interpreted as an exclusive or (sometimes referred to as “XOR”). On the contrary, expressions such as “A or B” covers all the cases “A and not B”, “B and not A” and “A and B”, unless otherwise indicated. The mere fact that certain measures are recited in mutually different dependent claims does not indicate that a combination of these measures cannot be used to advantage. Any reference signs in the claims should not be construed as limiting the scope.

It is also to be noted that features from the various embodiments described herein may freely be combined, unless it is explicitly stated that such a combination would be unsuitable.

The invention is not restricted to the described embodiments in the figures, but may be varied freely within the scope of the claims.

1. A milking plant system comprising:
a local server (120) arranged at a farm (150), the local server (120) being configured to obtain configuration data (CF) from a remote server (110) over at least one network (130), and
a set of farm components (141, 142, 143) each of the farm components being operatively connected to a respective controller (C1, C2, C3) that is configurable by a set of configuration parameters comprised in the configuration data (CF), wherein each of said respective controllers (C1, C2, C3) is communicatively connected to the local server (120), wherein
the local server (120) is configured to:
receive a configuration file (CF{ID}) from the remote server (110), the configuration file (CF{ID}) comprising a respective set of the configuration parameters (CF1, CF2, CF3) for each of said respective controllers (C1, C2, C3), the configuration file (CF{ID}) having been generated based on a defining message (D{ID}) identifying the components in the set of farm components (141, 142, 143); and
transmit, in response to the configuration file (CF{ID}), the respective set of the configuration parameters (CF1, CF2, CF3) to each of said respective controllers (C1, C2, C3), and
each of said respective controllers (C1, C2, C3) is configured to:
receive the respective set of the configuration parameters (CF1, CF2, CF3), and in response thereto
set a configuration of the controller (C1, C2, C3) in accordance with the respective set of the configuration parameters (CF1, CF2, CF3) for that controller (C1, C2, C3).

2. The milking plant system according to claim 1, wherein:
each of the components in the set of farm components (141, 142, 143) comprises a respective machine-readable label (151, 152; 153) denoting a respective identity (ID1, ID2; ID3) of the component, the machine-readable label being configured to be read by an optical reader, a radio-frequency-identification reader and/or a near-field-communication reader, and
the defining message (D{ID}) is based on the machine-readable labels (151, 152; 153).

3. The milking plant system according to claim 2, further comprising a mobile terminal (160) comprising at least one reader configured to:
read each of the machine-readable labels (151, 152; 153), and based thereon
produce the defining message (D{ID}), and
transmit the defining message (D{ID}) to the remote server (110).

4. The milking plant system according to claim 3, wherein the mobile terminal (160) is further configured to:
receive user-input data specifying how each said component in the set of farm components (141, 142, 143) is arranged in relation to at least one other said component of the milking plant system at the farm (150), and
produce the defining message (D{ID}) on the further basis of the user-input data.

5. The milking plant system according to claim 1, further comprising a mobile terminal (160) configured to:
receive positioning signals (PSS) from a positioning system (170), and based thereon
determine a position of the mobile terminal (160),
produce the defining message (D{ID}) based on the position for of the mobile terminal (160), and
transmit the defining message (D{ID}) to the remote server (110).

6. The milking plant system according to claim 1, further comprising an auxiliary server (180) that disposes of a second database (185) containing farm installation data describing the configuration of each said component in the set of farm components (141, 142, 143), the configuration being linked to a respective identity (ID1, ID2; ID3) of each component in the set of farm components (141, 142, 143), and the auxiliary server (180) is configured to:
produce the defining message (D{ID}) based on the respective identity (ID1, ID2; ID3) of each said component in the set of farm components (141, 142, 143), and
transmit the defining message (D{ID}) to the remote server (110).

7. The milking plant system according to claim 1, wherein said respective controllers (C1, C2, C3) is at least one of:
a milking controller operatively connected to a milking parlor,
a cleaning controller operatively connected to a cleaning arrangement configured to perform a clean-in-place procedure in respect of at least a part of a milking parlor, and
a cooling controller operatively connected to a cooling tank configured to hold extracted milk.

8. The milking plant system according to claim 7 wherein:
the milking parlor further comprises at least one milking point that is connected to a vacuum source, at least one pulsator and at least one milk meter, and the milking controller is configured to monitor the at least one milking point, the vacuum source, the at least one pulsator and at the least one milk meter.

9. A computer-implemented method, which is performed in at least one processor in a local server (120) of a milking plant system at a farm (150) and in each of a respective controller (C1, C2, C3) being operatively connected to a farm component in a set of farm components (141, 142, 143) comprised in the milking plant system, the respective controller (C1, C2, C3) being configurable by a set of configuration parameters comprised in the configuration data (CF) obtained from a remote server (110) over at least one network (130), wherein each of said respective controllers (C1, C2, C3) is communicatively connected to the local server (120), the method comprising:
receiving in the local server (120) a configuration file (CF{ID}) from the remote server (110), the configuration file (CF{ID}) comprising a respective set of configuration parameters (CF1, CF2, CF3) for each of said respective controllers (C1, C2, C3), and the configuration file (CF{ID}) having been generated based on a defining message (D{ID}) identifying the components in the set of farm components (141, 142, 143); and
transmitting, in response to the configuration file (CF{ID}), the respective set of the configuration parameters (CF1, CF2, CF3) from the local server (120) to each of said respective controllers (C1, C2, C3), and
in each of said respective controllers (C1, C2, C3):
receiving the respective set of the configuration parameters (CF1, CF2, CF3), and in response thereto
setting a configuration of the controller (C1, C2, C3) in accordance with the respective set of configuration parameters (CF1, CF2, CF3) for that controller (C1, C2, C3).

10. The method according to claim 9, wherein each of the components in the set of farm components (141, 142, 143) comprises a respective machinereadable label (151, 152; 153) denoting a respective identity (ID1, ID2; ID3) of the component, the machine-readable label being configured to be read by an optical reader, a radio-frequency-identification reader and/or a near-field-communication reader, and wherein the method further comprises:
producing the defining message (D{ID}) based on the machine-readable labels (151, 152; )

11. The method according to claim 10, further comprising:
reading each of the machine-readable labels (151, 152; 153) by a reader comprised in a mobile terminal (160),
producing, based thereon, the defining message (D{ID}) in the mobile terminal (160), and
transmitting the defining message (D{ID}) from the mobile terminal (160) to the remote server (110).

12. The method according to claim 11, further comprising:
receiving in the mobile terminal (160) user-input data specifying how each said component in the set of farm components (141, 142, 143) is arranged in relation to at least one other said component in a milking plant installation at the farm (150), and
produce the defining message (D{ID}) in the mobile terminal (160) on the further basis of the user-input data.

13. The method according to claim 9, further comprising:
receiving positioning signals (PSS) from a positioning system (170) in a mobile terminal (160), and based thereon
determining a position of the mobile terminal (160),
producing the defining message (D{ID}) in the mobile terminal (160) based on the position of the mobile terminal (160), and
transmitting the defining message (D{ID}) from the mobile terminal (160) to the remote server (110).

14. The method according to claim 9, further comprising:
producing the defining message (D{ID}) based on the respective identity (ID1, ID2; ID3) of each said component in the set of farm components (141, 142, 143) in an auxiliary server (180) using farm installation data describing the configuration of each said component in the set of farm components (141, 142, 143), the configuration being linked to a respective identity (ID1, ID2; ID3) of each component in the set of farm components (141, 142, 143), and the farm installation data being stored in a second database (185) disposed by the auxiliary server (180); and
transmitting the defining message (D{ID}) from the auxiliary server (180) to the remote server (110).

15. The method according to claim 9, wherein said respective controllers (C1, C2, C3) is at least one of:
a milking controller operatively connected to a milking parlor,
a cleaning controller operatively connected to a cleaning arrangement configured to perform a clean-in-place procedure in respect of at least a part of a milking parlor, and
a cooling controller operatively connected to a cooling tank configured to hold extracted milk.

16. The method according to claim 15, wherein:
the milking parlor further comprises at least one milking point that is connected to a vacuum source, at least one pulsator and at least one milk meter, and the milking controller is configured to monitor the at least one milking point, the vacuum source, the at least one pulsator and at the least one milk meter.

17. A non-volatile computer-readable medium on which is stored a computer program (425) comprising software for executing the method according claim 8 when the computer program (425) is run on a processing unit (410).

18. (canceled).

19. The miking plant system of claim 5, wherein
each given said component in the set of farm components (141, 142, 143) comprises a respective machine-readable label (151, 152; 153) denoting an identity of the given component;
the defining message (D{ID}) is based on the machine-readable labels (151, 152; 153); and
the mobile terminal comprises a reader configured to read the machine-readable labels.

20. The milking plant system of claim 19, wherein
the mobile terminal is further configured to receive user-input data specifying how each of the components in the set of farm components is arranged in relation to at least one other of the components of the milking plant system, and
the mobile terminal is configured to produce the defining message D{ID} on the further basis of the user-input data.

21. The method of claim 13, wherein
each given said component in the set of farm components (141, 142, 143) comprises a respective machine-readable label (151, 152; 153) denoting an identity of the given component,
the mobile terminal comprises a reader configured to read the machine-readable labels, and
the method further comprises producing the defining message (D{ID}) based on the machine-readable labels (151, 152; 153).

22. The method of claim 21, wherein
the mobile terminal is further configured to receive user-input data specifying how each of the components in the set of farm components is arranged in relation to at least one other of the components of the milking plant system, and
the mobile terminal is configured to produce the defining message D{ID} on the further basis of the user-input data.

23. The milking plant of claim 8, wherein the cooling tank comprises at least one agitating member, an evaporator and a compressor; and the cooling controller is configured to monitor the at least one agitating member, the evaporator and the compressor.

24. The method of claim 16, wherein the cooling tank comprises at least one agitating member, an evaporator and a compressor; and the cooling controller is configured to monitor the at least one agitating member, the evaporator and the compressor.
